(19) United States
(12) Patent Application Publication
(10) Pub. No.: US 2015/0128739 A1
(43) Pub. Date: May 14, 2015

(54) DRIVING DEVICE FOR WASHING MACHINE

(71) Applicant: Dongbu Daewoo Electronics Corporation, Seoul (KR)

(72) Inventor: Hyoung Tae YOON, Incheon (KR)

(73) Assignee: Dongbu Daewoo Electronics Corporation, Seoul (KR)

(21) Appl. No.: 14/109,621

(22) Filed: Dec. 17, 2013

(30) Foreign Application Priority Data
Nov. 12, 2013 (KR) 10-2013-0136661

(51) Int. Cl. D06F 37/30; H02K 7/116

(52) U.S. Cl. CPC D06F 37/30; H02K 7/116
USPC 74/421 A

(57) ABSTRACT

Disclosed is a driving device for a washing machine including a bearing housing affixed to a lower surface of a tub; a spin-drying shaft that extends through the bearing housing, having an upper end coupled with a drum, and having a serration at an outer circumferential edge of a lower end; a washing shaft that extends through the spin-drying shaft so that opposed ends of the spin-drying shaft extend beyond and end of the washing shaft, having an upper end coupled with a pulsator or agitator, and having a serration or gear a lower end; a driving unit configured to deliver power to rotate the spin-drying shaft and/or the washing shaft; and a driving unit support part having one end coupled to the bearing housing and another end fastened with the driving unit.

### CROSS-REFERENCE TO RELATED APPLICATIONS

This application claims priority to Korean Patent Application No. 10-2013-0136661, filed on Nov. 12, 2013, which is hereby incorporated herein in its entirety by reference.

### TECHNICAL FIELD

The present disclosure relates to a driving device for a washing machine, and more particularly, to a driving device for a washing machine that is configured to minimize power loss during a spin-drying cycle or a washing cycle of the washing machine, increase efficiency of a driving unit, and reduce noise and vibration while driving the washing machine. The driving device includes a spin-drying shaft coupled to an internal rotor and a washing shaft coupled to an external rotor that can directly rotate independently of each other.

### BACKGROUND

A washing machine is an apparatus which performs a washing cycle, a rinsing cycle, and a spin-drying cycle for laundry using the driving force of a motor.

Generally, a washing machine may be classified into a pulsator type washing machine (washing machine), a drum type washing machine, an agitator type washing machine, or other type washing machine depending on the type of washing technique that it uses.

FIG. 1 illustrates a cross-sectional view of a conventional washing machine 1. As illustrated in FIG. 1, in the washing machine 1, a rotating shaft 7 is configured to be rotated by a driving part 5 and a pulsator 8, at a lower end of a drum 4, is configured to be rotated at a high speed with sufficient power to form a vortex. The washing machine that washes laundry in the drum 4 using a vortex is widely used.

As illustrated in FIG. 1, the conventional washing machine 1 includes a cabinet 2 which supports a body.

Generally, a front upper end of the cabinet 2 is provided with an operation control part 9. The washing cycle, the rinsing cycle, and the spin-drying cycle can be selectively or sequentially performed by using the operation control part 9 by the user.

A tub 3 is mounted in the cabinet 1 and holds washing water which is supplied through a water supply valve (not illustrated).

The drum 4 is mounted in the tub 3 and includes a space to receive laundry and facilitate washing therein.

The pulsator 8 is mounted on a bottom surface of the drum 4 and rotate to cause a vortex in the washing water.

The rotating shaft 7 penetrates or extends through the tub 3 and the drum 4.

A lower end of the tub 3 is provided with the driving part 5 which can be connected to a gear 6 by a pulley.

A driving force from the driving part 5 is delivered to the reduction part 6 by the pulley, and the shaft 7 is rotated by the reduced rotating power to perform the washing cycle, the rinsing cycle, or the spin-drying cycle.

Generally, in the case of the washing cycle, the driving part 5 rotates at about 100 to 150 rpm, and in the case of the spin-drying cycle, the driving part rotates at 700 rpm or more.

As a rotation power that has different rpms is generated by a single driving part, significant power loss of the driving part may occur, such that the efficiency of the driving part is reduced.

Vibration and noise may also be increased at the time of driving the washing machine depending on the indirect driving type.

A conventional washing machine with such a motor may be disclosed in Korean Utility Model Application No. 20-1997-021150.

### SUMMARY

Embodiments of the present invention are directed to a driving device for a washing machine which minimizes power loss, implements various driving (e.g., washing and/or motor) types, and reduces noise and vibration that occur during the driving of a washing machine, by a driving unit (e.g., motor) that may directly deliver a driving force to a washing shaft when washing, and to a spin-drying shaft when spin-drying. The driving unit may simultaneously or independently drive the washing shaft and the spin-drying shaft.

One or more exemplary embodiments of the driving device for a washing machine includes a bearing housing affixed to a lower surface of a tub; a spin-drying shaft that extends or penetrates through the bearing housing, having an upper end coupled to a drum in the tub, and having a serration or gear at a lower end; a washing shaft, extending or penetrating through the spin-drying shaft, having an upper end coupled to a pulsator or agitator, and having a serration or gear at a lower end; a driving unit configured to deliver power to rotate the spin-drying shaft and/or the washing shaft; and a driving unit support structure having one end fastened to or in contact with the bearing housing and another end fastened or affixed to or in contact with the driving unit.

In one or more embodiments, the driving unit may include an insulating member comprising an insulating material; an internal stator on an inner side of the insulating material; an internal rotor facing the internal stator; an external stator on an outer side of the insulating material; an external rotor facing the external stator; an internal rotor support member having one end coupled to the inner rotor and another end coupled to a spin-drying shaft support part; and an external rotor support member having one end coupled to the external rotor and another end coupled to a washing shaft support part, in which the internal rotor and the external rotor may rotate independently or simultaneously.

In one or more embodiments, an inner circumference of the spin-drying shaft support part may have a serration or gear corresponding to the serration or gear at the lower end of the spin-drying shaft. Moreover, in one or more embodiments, the spin-drying shaft support part may be interlocked with the spin-drying shaft.

In one or more embodiments an inner circumference edge of the washing shaft support part may have a serration or gear corresponding to the serration or gear at the lower end of the washing shaft. Moreover, in one or more embodiments, the washing shaft support may be interlocked with the washing shaft.

In one or more embodiments, a rotatable spin-drying shaft may be supported by the bearing housing, a spin-drying shaft upper bearing and a spin-drying shaft lower bearing.

In one or more embodiments, the washing shaft may be supported by an inner circumferential surface of the spin-drying shaft and by a washing shaft bearing that is rotatable independently of the spin-drying shaft.

In one or more embodiments, the internal rotor may rotate during the spin-drying cycle of the washing machine such that the drum fixed or fastened to the upper end of the spin-drying shaft rotates, and the external rotor may rotate during the washing cycle of the washing machine such that the drum does not rotate and the pulsator fixed or fastened to the upper end of the washing shaft may rotate.

In one or more embodiments, because the rotational driving force of the driving unit is directly delivered to the spin-drying shaft and/or the washing shaft, the spin-drying shaft rotates during the spin-drying cycle, and the washing shaft rotates during the washing cycle, thereby minimizing power loss.

In one or more embodiments of the driving device for a washing machine, the rotational driving force of the driving unit is directly delivered to the spin-drying shaft during the spin-drying cycle and is directly delivered to the washing shaft during the washing cycle, thereby improving the efficiency of the driving unit.

In one or more embodiments of the driving device for the washing machine, the rotational driving force of the driving unit is selectively delivered directly to the spin-drying shaft or the washing shaft, thereby reducing noise or vibration occurring during driving of the washing machine.

In one or more embodiments of the driving device for the washing machine, the rotational driving force of the driving unit is simultaneously delivered to the spin-drying shaft and the washing shaft, if necessary, to rotate the spin-drying shaft and the washing shaft so as to implement various driving types, thereby improving the performance of the washing machine.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates a cross-sectional view of a conventional washing machine.

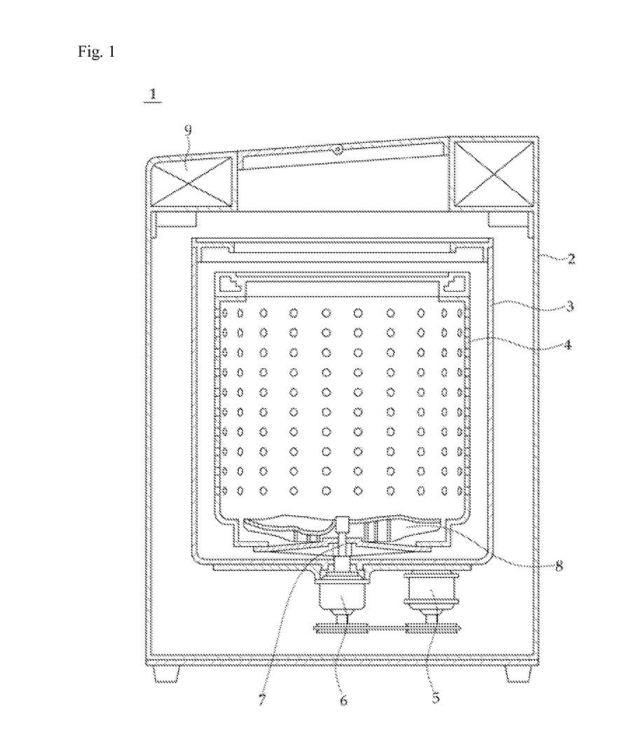

FIG. 2 is a cross-sectional view of a driving device for a washing machine according to an exemplary embodiment of the present invention.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

Exemplary embodiments of the present disclosure will be described in detail with reference to the accompanying drawings. First, in adding reference numerals to components of each drawing, like components are denoted by like reference numerals.

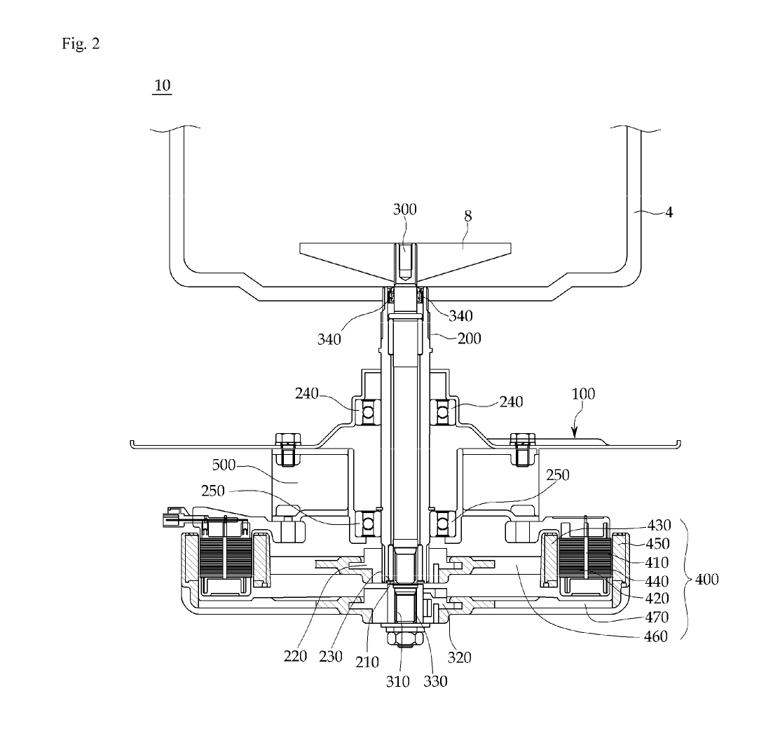

FIG. 2 is a cross-sectional view of a driving device 10 for a washing machine according to one or more exemplary embodiments of the present invention.

The driving device for a washing machine according to an exemplary embodiments of the present disclosure will be described with reference to FIG. 2. The driving device 10 for a washing machine according to exemplary embodiments of the present disclosure includes a bearing housing 100, a spin-drying shaft 200, a washing shaft 300, a driving unit 400, and a driving unit support part 500.

As illustrated in FIG. 2, the bearing housing 100 is fixed or fastened to a lower surface of a tub 3 (not shown). In one or more embodiments, the bearing housing 100 may be fixed or fastened to the lower surface of the tub 3 by bolts and nuts and may be provided with one or more insertion holes into which the bolt is inserted. In other embodiments, the bearing housing 100 may be fixed or fastened to the lower surface of the tub 3 in other ways.

The rotatable spin-drying shaft 200 is configured to extend or penetrate through the bearing housing 100. An upper end of the spin-drying shaft 200 is coupled with a drum 4, and an outer circumferential edge of a lower, e.g., lowermost, end of the spin-drying shaft 200 has a serration or gear 210 for coupling the spin-drying shaft 200 with a spin-drying shaft support 220 to be described below.

As illustrated in FIG. 2, according to one or more other exemplary embodiments of the present disclosure, the spin-drying shaft 200 is supported by the bearing housing 100, a rotatable spin-drying shaft upper bearing 240 and a rotatable spin-drying shaft lower bearing 250.

Although not necessarily limited thereto, in one embodiment, the spin-drying shaft 200 may be supported by spin-drying shaft bearings that include (but are not limited to) more than three spin-drying shaft bearings, when the spin-drying shaft 200 is longer than a predetermined length.

The washing shaft 300 is within the concentric spin-drying shaft 200, and extends and/or penetrates through the spin-drying shaft 200 so that opposite ends of the washing shaft 300 extend beyond the uppermost and lowermost ends. An upper, e.g., uppermost end of the washing shaft 300 is coupled to a pulsator 8, and an outer circumferential edge of a lower, e.g., lowermost end of the washing shaft 300 has a serration or gear 310 for coupling the washing shaft 300 to a washing shaft support 320 as described below.

As illustrated in FIG. 2, according to one or more other exemplary embodiments of the present disclosure, the washing shaft 300 is supported by an inner circumferential surface of the spin-drying shaft 200 and a rotatable washing shaft bearing 340 that can rotate independently of the spin-drying shaft 200.

Although not necessarily limited thereto, in one embodiment, the washing shaft 300 can be supported by spin-drying shaft bearings that include (but are not limited to) more than two spin-drying shaft bearings when the washing shaft 300 is longer than a predetermined length.

The driving unit 400 is configured to directly deliver power to the spin-drying shaft 200 or the washing shaft 300, to selectively rotate the spin-drying shaft 200 or the washing shaft 300.

One end of the driving unit support part 500 is fixed or fastened to the bearing housing 100, and another end is fixed or fastened to the driving unit 400. That is, the driving unit 400 is mounted on a lower portion of the bearing housing and./or the driving unit support part 500 to directly deliver power for rotating the spin-drying shaft 200 and/or the washing shaft 300. Although not necessarily limited thereto, in one embodiment, the other end of the driving unit support part 500 may be fixed or fastened to the driving unit 400 by one or more fixing components or fasteners, such as a bolt and nut, a rivet, a key, or a pin. In other embodiments, other fixing or fastening components can be used.

As illustrated in FIG. 2, according to another exemplary embodiment of the present invention, the driving unit 400 includes an insulating member 410, an internal stator 420, an internal rotor 430, an external stator 440, an external rotor 450, an internal rotor support member 460, and an external rotor support part 470.

The insulating member 410 comprises an insulating material having predetermined rigidity or stiffness and is provided at a central portion of the driving unit 400.

The internal stator 420 is on an inner side of the insulating member 410. In an exemplary embodiment(s) of the present invention, the internal stator 420 may include a plurality of stator coils, arranged in a circular configuration.

The internal rotor 430 faces the internal stator 420, and the internal rotor 430 and the internal stator 420 are spaced apart from each other by a predetermined interval. Although not necessarily limited thereto, in one or more exemplary embodiment(s) of the present invention, an outermost side of the internal rotor 430 may include an internal rotor yoke. The internal rotor yoke may comprise a metal to form a magnetic flux path. The internal rotor yoke may include a magnet at a predetermined interval from the stator coils in the internal stator 420.

The external stator 440 is on an outer side of the insulating member 410. Although not necessarily limited thereto, according to exemplary embodiment(s) of the present invention, the external stator 440 may include a plurality of stator coils arranged in a circular configuration, concentric with the circular configuration of stator coils in the internal stator 420.

The external rotor 450 faces the external stator 440. Moreover, the external rotor 450 and the external stator 440 are spaced apart from each other at a predetermined interval. Although not being necessarily limited thereto, in exemplary embodiment(s) of the present invention, an outermost side of the external rotor 450 may include an external rotor yoke. The external rotor yoke may comprise a metal and may cause a magnetic flux path. The external rotor yoke may include a magnet at a predetermined interval from the stator coils in the external stator 430.

In one or more embodiments, a first end of the internal rotor support member 460 is coupled with the internal rotor 430, and other end is coupled to a spin-drying shaft support 220.

In one or more embodiments, a first end of the external rotor support member 470 is coupled with the external rotor 450, and another end is coupled to the washing shaft support 320.

In one or more embodiments, the internal rotor 430 and the external rotor 450, may rotate independently of each other, or may simultaneously rotate.

When power is applied and the operator or user selects a washing cycle, a rinsing cycle, or a spin-drying cycle using the operation controller part 9, power is supplied to the internal stator 420 or the external stator 440 by a controller (not illustrated) to form an electromagnetic field that interacts with the magnets in the rotor and/or stator. Thus, the internal rotor 430 or the external rotor 440 rotates by the electromagnetic field formed by the stators 420 and 440 to generate a rotating power.

According to at least one exemplary embodiment of the present disclosure, the driving unit 400 may be configured to include a brushless DC motor (BLDC motor).

As illustrated in FIG. 2, according to another exemplary embodiment of the present invention, the inner circumferential edge of the spin-drying shaft support 220 includes a serration or gear 230 corresponding to the serration 210 which is at the outer circumferential edge of the lower end of the spin-drying shaft. Therefore, the spin-drying shaft support 220 may be coupled by meshing between the serration or gear 230 at an inner circumferential edge of the spin-drying shaft support and the serration or gear 210 at the lower end of the spin-drying shaft 200. According to at least one embodiment, the serration or gear 230 at the inner circumferential edge of the spin-drying shaft support 220 may have a portion which does not reach an uppermost edge of the spin-drying shaft support 220. In such embodiments, the portion is conveniently referred to as an edentulous section.

As illustrated in FIG. 2, according to one or more exemplary embodiments of the present invention, the inner circumferential edge of the washing shaft support 320 includes a serration or gear 330 corresponding to the serration or gear 310 at the outer circumferential edge of the lower end of the washing shaft 300. Therefore, the washing shaft support 320 is coupled by meshing between the serration or gear 330 at the inner circumferential edge of the washing shaft support 320 and the serration or gear 310 at the lower end of the washing shaft 300. According to at least one embodiment, the serration or gear 330 at the inner circumferential edge of the washing shaft support 320 may have a portion which does not reach an uppermost edge of the washing shaft support 320. In other embodiments, the portion can be configured differently. In such embodiments, the portion is conveniently referred to as an edentulous section.

When power is applied to the stator coils of the internal stator 420 during the spin-drying cycle, an electromagnetic field is generated on the stator coils and the magnets at the internal rotor yoke. The electromagnetic field is generated by the aforementioned meshing between the spin-drying shaft support 220 and the lower end of the spin-drying shaft 200. The rotating power of the electromagnetic field is delivered to the spin-drying shaft support 220 by the internal rotor support member 460, and rotating power is delivered to the spin-drying shaft 200 by meshing between the serration or gear 230 at the inner circumferential edge of the spin-drying shaft support 220 and the serration or gear 210 at the lower end of the spin-drying shaft 200. The spin-drying cycle is performed while the drum 4 coupled with the upper end of the spin-drying shaft 200 rotates based on the rotation of the spin-drying shaft 200.

When power is applied to the stator coils of the external stator 440 during the washing cycle, an electromagnetic field is generated on the stator coils and the magnets in the external rotor yoke by the aforementioned meshing between the washing shaft support 320 and the lower end of the washing shaft 300. The rotating power of the electromagnetic field is delivered to the washing shaft support 320 by the external rotor support member 470, and rotating power is delivered to the washing shaft 300 by meshing between the serration or gear 330 at the inner circumferential edge of the washing shaft support 320 and the serration or gear 310 at the lower end of the washing shaft 300. The washing cycle is performed while the pulsator 8 coupled to the upper end of the washing shaft 300 rotates based on the rotation of the washing shaft 300.

In one or more embodiments, the internal rotor 430 rotates during the spin-drying cycle of the washing machine such that the drum 4 fastened to the upper end of the spin-drying shaft 200 rotates, and the external rotor 450 rotates during the washing cycle of the washing machine such that the drum 4 does not rotate and the pulsator 8 fastened to the upper end of the washing shaft 300 may rotate, thereby minimizing the power loss of the driving unit, and increasing the efficiency.

However, in one or more embodiments, if necessary, power may be simultaneously applied to the internal stator 420 and the external stator 440 by the controller (not illustrated) to generate an electromagnetic field, thereby simultaneously rotating the internal rotor 430 and the external rotor 450. In this case, the spin-drying shaft 200 and the washing shaft 300 simultaneously rotate.

In one or more embodiments, power can be simultaneously applied to the internal stator and the external stator by the controller part (not illustrated) to generate the electromagnetic fields opposite to each other, thereby rotating the internal rotor 430 and the external rotor 450 so that the rotation directions of the internal rotor 430 and the external rotor 450 differ from each other. In this case, the spin-drying shaft 200 and the washing shaft 300 simultaneously rotate, but have rotation directions opposite to each other to realize various driving motions, thereby improving the performance of the washing machine.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A driving device for a washing machine, comprising:
a bearing housing coupled to a lower surface of a tub;
a spin-drying shaft that extends through the bearing housing, having an upper end coupled to a drum, and having a serration or gear at a lower end;
a washing shaft that extends through the spin-drying shaft, wherein one or more ends of the spin-drying shaft extend beyond an end of the washing shaft, the washing shaft having an upper end coupled to a pulsator or agitator, and having a serration or gear at a lower end;
a driving unit configured to deliver power to and rotate the spin-drying shaft and the washing shaft; and
a driving unit support part having one end coupled to the bearing housing and another end coupled to the driving unit.

2. The driving device for a washing machine of claim 1, wherein the driving unit comprises:
an insulating member comprising insulating material;
an internal stator on an inner side of the insulating member; and
an internal rotor facing the internal stator.

3. The driving device for a washing machine of claim 2, wherein the driving unit further comprises:
an external stator on an outer side of the insulating member; and
an external rotor facing the external stator;

4. The driving device for a washing machine of claim 3, wherein the driving unit further comprises:
an internal rotor support member having one end coupled to the inner rotor and another end coupled to a spin-drying shaft coupling part; and
an external rotor support member having one end coupled to the external rotor and the other end coupled to a washing shaft coupling part.

5. The driving device for a washing machine of claim 3, wherein the internal rotor and the external rotor are configured to rotate independently of each other during a first washing operation and simultaneously during a second washing operation.

6. The driving device for a washing machine of claim 4, wherein an inner circumferential edge of the spin-drying shaft support is provided with a serration or gear corresponding to the serration or gear at the outer circumferential edge of the lower end of the spin-drying shaft, and the spin-drying shaft support is interlocked with the spin-drying shaft.

7. The driving device for a washing machine of claim 6, wherein an inner circumferential edge of the washing shaft support is provided with a serration corresponding to the serration or gear at the outer circumferential edge of the lower end of the washing shaft, and the washing shaft support is interlocked with the washing shaft.

8. The driving device for a washing machine of claim 7, wherein the spin-drying shaft is supported by the bearing housing, a rotatable spin-drying shaft upper bearing and a rotatable spin-drying shaft lower bearing.

9. The driving device for a washing machine of claim 8, wherein the washing shaft is supported by an inner circumferential surface of the spin-drying shaft and a rotatable washing shaft bearing that rotates independently of the spin-drying shaft.

10. The driving device for a washing machine of claim 9, wherein the internal rotor and the drum rotate during a spin-drying cycle of the washing machine, and the external rotor and the pulsator or agitator rotates during the washing cycle of the washing machine.

11. A method for driving a washing machine, comprising:
during a spin-drying cycle, rotating a spin drying shaft coupled to an internal rotor, wherein a drum is fastened or affixed to an upper end of the spin-drying shaft; and
during a washing cycle, rotating a washing shaft coupled to an external rotor wherein a pulsator or agitator is fastened or affixed to an upper end of the washing shaft.

12. The method of claim 11, wherein an internal rotor support member of the washing machine has one end coupled to an internal rotor and another end coupled to a spin-drying shaft support, and an external rotor support member of the washing machine has one end coupled to an external rotor and another end coupled to a washing shaft support, wherein rotating the internal rotor and rotating the external rotor is executed independently or simultaneously.

13. The method of claim 12, wherein the washing shaft is supported by an inner circumferential surface of the spin-drying shaft and a rotatable washing shaft bearing that rotates independently of the spin-drying shaft.

14. The method of claim 12, wherein the spin-drying shaft is supported by the bearing housing, a rotatable spin-drying shaft upper bearing and a rotatable spin-drying shaft lower bearing.

15. The method of claim 12, wherein an inner circumferential edge of the spin-drying shaft support has a serration or gear corresponding to a serration or gear at the outer circumferential edge of the lower end of the spin-drying shaft.

16. The method of claim 15, wherein the spin-drying shaft support is interlocked to the spin-drying shaft and rotates the spin-drying shaft based on rotating power received from an internal stator coil.

17. The method of claim 12, wherein an inner circumferential edge of the washing shaft support is provided with a serration or gear corresponding to the serration or gear at the outer circumferential edge of the lower end of the washing shaft.

18. The method of claim 17, wherein the washing shaft support is interlocked with the washing shaft and rotates the washing shaft based on rotating power received from an external stator coil.
